(19) United States
(12) Patent Application Publication
(10) Pub. No.: US 2021/0092496 A1
(43) Pub. Date: Mar. 25, 2021

(54) SYSTEMS AND METHODS FOR ASSESSING A CONDITION OF A VEHICLE REFRIGERATION SYSTEM

(71) Applicant: ENERGIZER AUTO, INC., St. Louis, MO (US)

(72) Inventors: Ken Pistone, Rowlett, TX (US); Vincent Carrubba, Belle Harbor, NY (US)

(21) Appl. No.: 16/841,424

(22) Filed: Apr. 6, 2020

Related U.S. Application Data
(63) Continuation of application No. 14/695,403, filed on Apr. 24, 2015.
(60) Provisional application No. 61/985,112, filed on Apr. 28, 2014.

(51) Int. Cl. H04Q 9/00; F25B 45/00; F25B 49/00

(52) U.S. Cl. CPC H04Q 9/00; F25B 45/00; F25B 49/005; F25B 2500/24; F25B 2700/21151; F25B 2500/19; F25B 2327/001; F25B 2345/001; F25B 2700/195; F25B 2700/21163; F25B 2700/1933

(57) ABSTRACT

A system for assessing and servicing a vehicle refrigeration system includes at least one sensor and at least one user device communicatively coupled to the at least one sensor. The at least one sensor is configured for attachment to an air vent portion of a vehicle, and is configured to collect at least one measurement. The at least one user device is configured to receive the at least one measurement, process the at least one measurement and generate at least one result, and display the at least one result.

### CROSS-REFERENCE TO RELATED APPLICATIONS

This application is a continuation of U.S. Non-Provisional application Ser. No. 14/695,403, filed on Apr. 24, 2015, currently pending, which claims the benefit of U.S. Provisional Application Ser. No. 61/985,112, filed on Apr. 28, 2014, now expired, the entireties of which are hereby incorporated herein by reference.

### FIELD

Embodiments of the present invention relate to systems, methods and apparatus for fluid delivery. In particular, the present invention relates to assessing conditions of a refrigeration system based on parameters obtained from the liquid line of a refrigeration system.

### BACKGROUND

Refrigeration systems have been relied upon as a principal source of cooling in a variety of applications. Refrigeration systems are found in, for example, vehicles, commercial buildings and residential buildings. Many refrigeration systems (air conditioning systems) use a circulating medium (for example, refrigerant) that absorbs and removes heat from the space to be cooled and subsequently rejects the absorbed heat elsewhere.

Refrigeration systems operate based on principles of the Reversed Carnot Cycle, also known as the Vapor-Compression Refrigerant Cycle. The ability to achieve cooling depends to some degree on the level of liquid refrigerant present in the system. The amount of fluid in the refrigerant system may directly influence the performance of vapor-compress ion-refrigeration systems. Under charging the system of refrigerant may cause the system to not operate at design set points, risking shortened compressor life, poor cooling performance, and ultimately putting the compressor at risk of mechanical failure. Over charging may cause liquid refrigerant to enter the compressor resulting in damage to the compressor, increased high side pressure putting more load on the compression system resulting in poorer fuel economy along with increased wear on the compressor, higher pressures also can result in exceeding the refrigerant systems pressure safety limits and increasing compressor operating temperatures both resulting in the system turning off and affecting overall cooling performance.

Several factors may adversely affect the level of refrigerant in the system. For example, the refrigeration system may be subject to significant swings in temperature and frequent thermal cycling due to the action of the system itself and the heat produced by power sources (for example, engines). Under these conditions, joints and fittings may tend to expand and contract, permitting refrigerant to slowly leak out of the system. In another example, the hoses used may be slightly permeable to the refrigerant, which may also permit the refrigerant to slowly leak out of the hoses. Accordingly, maintenance of refrigerant systems may require monitoring the refrigerant level and periodic re-charging of the refrigerant as required.

Charge adequacy may be checked manually by trained service technicians using pressure gauge measurements, temperature measurements, and a pressure to refrigerant temperature relationship chart for the particular refrigerant resident in the system. For refrigerant systems, which use a thermal expansion valve (TXV) or an electronic expansion valve (EXV), the superheat of the refrigerant entering the compressor may be regulated at a fixed value, while the amount of subcooling of the refrigerant exiting the condenser varies. In most systems, the “subcooling method” may be used as an indicator for charge level. The amount of subcooling is calculated by determining the saturated refrigerant temperature from the refrigerant pressure measured between the outlet of the condenser coil and prior to the expansion device for the refrigerant in use. The saturated refrigerant temperature minus the actual refrigerant temperature measured between the outlet of the condenser coil and prior to the expansion device is determined and compared to a range of acceptance levels of subcooling.

A refrigerant pressure and temperature may be measured between the condenser outlet and prior to the expansion valve. The consumer may then refer to a pressure/temperature relationship chart for the refrigerant in use to determine the saturated refrigerant temperature at the measured pressure. Based on the measured pressure, the amount of cooling actually present at the current operating conditions (for example, outdoor temperature, indoor temperature, humidity, indoor airflow and the like) may be calculated. If the measured amount of cooling lies within the range of acceptable levels, the system is deemed to be properly charged. If not, the consumer may adjust the refrigerant charge by either adding a quantity of refrigerant to the system or removing a quantity of refrigerant from the system, as appropriate. Methods for determining the refrigerant charge level in an air conditioning system are described in U.S. Pat. No. 5,239,865 to Salzer et al.; U.S. Pat. No. 5,481,481 to Frey et al.; U.S. Pat. No. 5,987,903 to Bathla; U.S. Pat. No. 6,101,820 to Cheballah; and U.S. Pat. No. 6,571,566 to Temple et al., and U.S. Patent Application Publication Nos. 2010/0089076 to Schuster et al. and 2012/0143528 to Kates, all of which are incorporated herein by reference.

U.S. Pat. No. 8,301,403 to Weick and U.S. Pat. No. 7,260,943 to Carrubba et al., and U.S. Patent Application Publication Nos. 2008-0022701 to Carrubba et al. and 2009-0113901 to Carrubba et al., all of which are incorporated herein by reference, describe various apparatus that may allow a consumer to measure the refrigerant pressure in an automobile air conditioner and to add refrigerant as needed.

Most of these prior art methods and apparatus provide only a qualitative determination of whether the charge level is below or above acceptable limits or require inputs from multiple sensors, including ambient temperature and humidity sensors, in order to determine refrigerant charge level, which increases the cost and complexity of the system. Many of the prior art apparatus and methods are expensive to maintain, costly, and are not easily used by a do-it-yourself consumer.

There is, therefore, a need for an improved method of determining refrigerant charge level in vapor-compression-refrigerant systems. There is also a need for a method of determining refrigerant charge level in a vapor-compression-refrigerant system that is both relatively inexpensive and reliable under a wide range of ambient temperature conditions.

The present disclosure provides many advantages, which shall become apparent as described below.

### SUMMARY

Systems and method of servicing a refrigeration system are described herein. In some embodiments, a method of servicing a vehicle refrigeration system includes providing one or more sensors to a portion of a vehicle refrigeration system; measuring, by at least one of the sensors, one or more parameters of the vehicle refrigeration system; assessing a condition of the refrigeration system of the vehicle based on at least one of the measured parameters; and removing the sensor from the vehicle refrigeration system after assessing the condition of the refrigeration system of the vehicle. At least one sensor is located in situ with the operating fluid refrigerant.

In some embodiments, a system for servicing a vehicle refrigeration system includes at least one sensor configured to couple to a portion of a vehicle refrigeration system such that the sensor is located in situ with the operating fluid refrigerant in the vehicle refrigeration system; and user equipment in electronic communication with the sensor, wherein the sensor communicates data to the user equipment.

In some embodiments, a kit for servicing a vehicle refrigeration system includes a fluid source, the fluid source configured to deliver fluid to the vehicle refrigeration system; and at least one sensor, the sensor being configured to removably couple to the refrigeration system such that the sensor is located in situ with the operating fluid refrigerant, and wherein the sensor is configured to provide one or more measurements of the vehicle refrigerant system to user equipment.

In some embodiments, a method of servicing a vehicle refrigeration system includes providing a set of sensors to an interior portion of a vehicle refrigeration system; measuring, by the set of sensors, a pressure and a temperature of some of the fluid in the vehicle refrigeration system; assessing a condition of the vehicle refrigeration system based on at least one of the measured parameters; and providing a system fluid to the vehicle refrigeration system. The set of sensors being configured to be removably coupled to the vehicle refrigeration system, and at least one of the sensors is in contact with a portion of a pressurized fluid in the vehicle refrigeration system. The level of the system fluid is based on the assessed condition obtained at the first port, and at least some of the system fluid is provided while assessing the condition of the vehicle refrigeration system.

In some embodiments, a method of servicing a vehicle refrigeration system includes providing an adapter to a vehicle refrigeration system comprising system fluid; determining a sub cooling value of the fluid in the refrigeration system; and providing a system fluid to the refrigeration system of the vehicle. The adapter includes a sensor that is positioned in situ with the operating fluid refrigerant in the vehicle refrigeration system and the sensor is capable of measuring a pressure and a temperature of the pressurized fluid. The level and/or amount of the system fluid are based on the subcooling value of the fluid, and at least some of the system fluid is provided while determining the subcooling value of the vehicle refrigeration system.

In some embodiments, a method of assessing a condition of a vehicle refrigeration system includes providing a plurality of sensors to a portion of a vehicle refrigeration system; measuring, by the two sensors, two or more parameters of the vehicle refrigeration system; and assessing a condition of the refrigeration system of the vehicle based on the two measured parameters. At least two of the plurality of sensors are positioned in situ with the operating fluid refrigerant in the refrigeration system.

In some embodiments, a method of assessing a condition of a vehicle refrigeration system, includes providing at least one sensor to an interior of a portion of piping of a vehicle refrigeration system or substantially proximate the interior of the portion of piping of the vehicle refrigeration system; determining a subcool value of a refrigerant circulating in the vehicle refrigeration system; assessing a condition of the refrigeration system of the vehicle based on at least one of the subcool value; and removing the sensor from the vehicle refrigeration system after assessing the condition of the refrigeration system of the vehicle. The subcool is based on at least one parameter received by at least one sensor.

In further embodiments, features from specific embodiments may be combined with features from other embodiments. For example, features from one embodiment may be combined with features from any of the other embodiments.

In further embodiments, additional features may be added to the specific embodiments described herein.

Further objects, features and advantages of the present disclosure will be understood by reference to the following drawings and detailed description.

### BRIEF DESCRIPTION OF THE DRAWINGS

Advantages of the present invention may become apparent to those skilled in the art with the benefit of the following detailed description and upon reference to the accompanying drawings in which:

FIG. 1 depicts a schematic of an embodiment of a vapor-pressure-refrigerant system.

FIG. 2A depicts a schematic an embodiment of obtaining one or more parameters from a pressure port of a refrigeration system.

FIG. 2B depicts a schematic of an embodiment of obtaining one or more parameters from a pressure port of a vehicle refrigeration system.

FIG. 3 depicts an embodiment of a fluid charging device coupled to first portion of a refrigeration system while obtaining data from a second portion of a refrigeration system through a wired connection.

FIG. 4 depicts an embodiment of a fluid charging device coupled to first portion of a refrigeration system while obtaining data using a cellular device.

FIG. 5 depicts schematic of another embodiment of a fluid charging device coupled to a portion of a refrigeration system while obtaining data from another portion of the vehicle refrigeration system through a wireless transmission.

FIG. 6 depicts a perspective view of a fluid charging device coupled to user equipment.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise.

As used herein “charging” refers to both charging and recharging of a system. Charging a system may include initially filling a unit with fluid. Recharging may refer to adding fluid to a unit that has some fluid in the unit. Recharging may be performed after a portion of the fluid has leaked out of the unit or the pressure/the fluid level has dropped below a desirable level. It will be appreciated that charging and recharging are often used interchangeably.

Many of the conventional measuring and charging apparatus utilize hoses or other means of conveyance to direct refrigerant to the measuring devices and may require that pressure and temperature measurements not be taken at the same location in situ, which may result in lower measurement accuracy, loss of refrigerant from the refrigeration system, and potential discharge of the refrigerant that was captured for the measurement into the atmosphere. For example, many prior art apparatus are designed to measure subcool as a means for determining charge status use hoses or other means of conveyance to funnel refrigerant to a sensor. The process of measuring in this manner may cause several deleterious effects. First, an amount of refrigerant (usually several ounces) may no longer flow within the refrigeration system, thus indicating a lower charge condition that was induced by the measurement that would not have been present sans the hose set. Secondly a vehicle system refrigerant charges have decreased over the years, thus a small loss in charge in the measurement hose can seriously impact overall system response of newer vehicle systems. Thirdly, refrigerant is a regulated substance and the release of refrigerant into the atmosphere is not allowed. The remaining refrigerant within the measurement hose should be reclaimed; however, many users may not have the equipment to recycle the refrigerant. Thus, refrigerant is typically released into the atmosphere and/or left in the hose.

The methods and systems described herein solve the above-described problems by placing a sensor in situ with the fluid of the refrigeration system. These methods provide an inexpensive determination of refrigerant level in the system with no losses of refrigerant to the atmosphere. These methods and systems also make it possible to obtain pressure and/or temperature readings from a high pressure portion of a vehicle refrigeration system.

As used herein “in situ” or “in situ with the fluid” refers to the sensor being at a position in the vehicle refrigeration system where the physical properties of the fluid are observed and/or measured, and that the fluid has not been substantially moved to another location. Thus, there is little, or substantially little, variation in the physical properties of the fluid at the time of measurement. For example, a sensor may be placed in the interior of a port connected to the refrigeration system, in the interior of the piping of the vehicle refrigeration system, or up to about 5 inches from the interior of the piping of the vehicle refrigeration system and experience the same physical parameters (for example, temperature and pressure) as the fluid circulating in the vehicle refrigeration system.

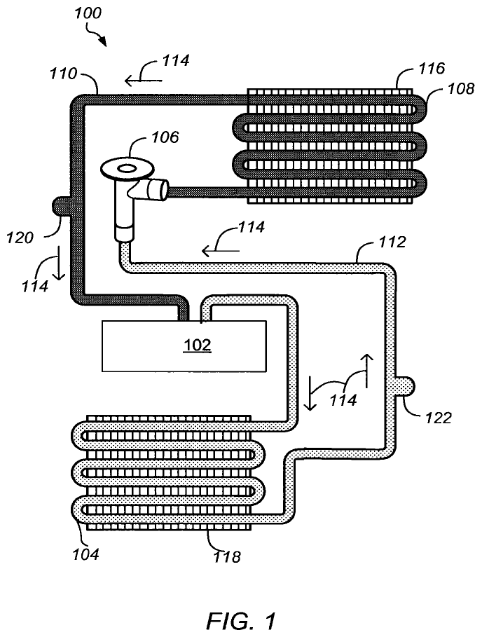

FIG. 1 depicts a schematic of an embodiment of a vapor-compression-refrigeration system. Vapor compression refrigeration system 100 may include compressor 102, condenser coil 104, expansion device 106, and evaporator coil 108 connected in a serial relationship with refrigerant flow through refrigerant piping 110 and 112 to form a refrigerant flow circuit.

In operation, the refrigerant may include a volume of hydrocarbons, halogenated hydrocarbons, other compressible fluids, and mixtures thereof. In some embodiments, refrigerant may include ammonia and/or water. Halogenated hydrocarbons include, but are not limited to, fluorinated hydrocarbons, chlorinated, fluorinated hydrocarbons, fluorinated ethers, 2,3,3,3-tetrafluorprop-1-ene (HFO-1234yf), 1,1,1,2-tetrafluorethane, dichlorodifluoromethane, or mixtures thereof. Commercially available fluid sources include, but are not limited to, HFO-1234yf refrigerants (for example, Genetron® (Honeywell, USA), Opteon® (DuPont™, USA), R-134a, R-12, or the like. In some embodiments, refrigerant may also include other suitable chemicals including, but not limited to, dyes and/or system lubricants.

Fluid circulating through the refrigerant circuit (shown by arrows 114) passes through evaporator coil 108 in the evaporator 116, which is in heat exchange relationship with air being passed over the evaporator coil 108 by a fan (not shown). As the air passes over the evaporator coil 108, the refrigerant absorbs the heat in the air passing over the evaporator coil, thereby cooling the air and evaporating the refrigerant. The fan circulates the cool air into an area designated for cooling.

After evaporation, the refrigerant circuit draws refrigerant vapor to compressor 102. In compressor 102, the refrigerant vapor is pressurized. Hot, high-pressure vapor exits compressor 102 and enters condenser coil 104. Condenser coil 104 is in heat exchange relationship with ambient temperature air passing over the condenser coil by a condenser fan (not shown). As the air passes through the condenser 118 and over the condenser coil 104, the refrigerant rejects heat to the air passing over, thereby heating the air and condensing the high-pressure refrigerant vapor to a high-pressure liquid refrigerant. The high-pressure liquid refrigerant leaving the condenser enters expansion valve 106. Expansion valve 106 expands the high-pressure refrigerant liquid to a lower temperature, lower pressure refrigerant liquid, before it enters evaporator coil 116.

Expansion device 106 may be a valve such as a thermostatic expansion valve (TXV), an electronic expansion valve (EXV), an orifice tube (O′T), a variable orifice tube (VaT) or other device designed to expand the fluid refrigerant. Expansion device 106 may regulate the amount of liquid refrigerant entering evaporator coil 116 in response to the superheat condition of the refrigerant exiting the evaporator 116. It should be understood that the invention is equally applicable for use in association with other refrigerant vapor compression systems such as heat pump systems. In a heat pump system, during cooling mode, the process is identical to that as described herein. In the heating mode of heat pump system, the cycle is reversed with the condenser and evaporator of the cooling mode acting as an evaporator and condenser, respectively.

Vapor compression refrigeration system 100 includes low-pressure port 120 and high-pressure port 122. Low-pressure port 120 is located downstream of evaporator 116 and before compressor 102. High-pressure port 122 is located downstream of condenser 118 and before expansion device 106. Low-pressure port 120 and high-pressure port 122 are both under pressure when refrigeration system 100 contains some level of refrigerant, however, the low pressure port has a lower pressure than the high-pressure port. In many refrigeration applications, system fluid (refrigerant) is added to refrigeration system through low-pressure port 120. In some instances, pressure and/or temperature measurements are obtained by coupling a pressure sensor and/or temperature sensor to low-pressure port 120. These measurements may be used to determine refrigerant level in the system, however, the measurements may not be as accurate as taking measurements from the high-pressure port. In some instances, compressor 102 is a variable compressor and adjustment of the internal pressure of the system may cause variations in pressure and/or temperature measurements obtained from the low-pressure port. In vehicles that have an internal heat exchanger, the pressure on the low-pressure port is increased as compared to pressures of vehicles that do not include an internal heat exchanger. In vehicles that are equipped with TXV or EXV expansion valves, the pressure on the low-pressure port may not reflect refrigerant level except at extreme under charge or over charge conditions as superheat is regulated by the expansion valve. For example, refrigerant systems that use a thermal expansion valve (TXV) or an electronic expansion valve (EXV), the superheat of the refrigerant entering the compressor may be regulated at a fixed value, while the amount of sub cooling of the refrigerant exiting the condenser varies. In such systems, low side pressure methods for determining charge may not accurately reflect the refrigerant level in the system.

In some embodiments, one or more sensors are provided to a vehicle refrigerant system (for example, low-pressure port 120, high-pressure port 122, or other portions of the piping of the vehicle refrigeration system). At least one of the sensors may measure one or more parameters of the fluid refrigeration system and communicate the data representative of the measured parameters to user equipment. At least one of the-sensors is located in situ with the fluid in the refrigeration system.

The sensor may include an inlet engageable with a portion of a refrigeration system (for example, a high-pressure or a low-pressure port of a vehicle refrigeration system). For example, the sensor may be part of an adapter. When coupled to the refrigeration system, the adapter may allow system fluid to flow into the adapter, contact a portion of the sensor, and then flow out of the adapter into the refrigeration system (a “flow-thru” adapter). Allowing the fluid to flow through the adapter and proximate the sensors allows accurate in situ measurements of the fluid properties and/or the system properties. The sensor may include a temperature component, a pressure component, a micro-processor, a transceiver an antenna, or combinations thereof.

The temperature component of the sensor may measure a temperature of the pressurized fluid of the refrigeration system, generate a signal representative of the measured temperature, and transmit the signal representative of the measured temperature to user equipment. In some embodiments, the temperature component is located in situ with the refrigerant in a portion of the refrigeration system. In some embodiments, the temperature component is part of, or coupled to, a fluid source and/or user equipment used to provide fluid to the refrigeration system. In some embodiments, the temperature component is coupled to an outside surface of the sensor or an outside surface of the vehicle, or other components of the vehicle or vehicle refrigeration system.

The pressure component may measure a pressure of the pressurized fluid of the refrigeration system, generate a signal representative of the measured pressure, and transmit the signal representative of the measured pressure to user equipment. In some embodiments, the pressure component is located in situ with the refrigerant in a portion of the refrigeration system. In some embodiments, the pressure component is part of, or coupled to, a fluid source and/or user equipment used to provide fluid to the refrigeration system.

Data received from the sensor may be processed by the user equipment. In some embodiments, a short range wireless signal (for example, at 2400-3483.5 MHz) is received by the user equipment. In some embodiments, data is received via a wired connection from the sensor to the user equipment. The user equipment receives the data, and uses the data to assess a condition of the refrigeration system. For example, the user equipment may include a processor that calculates fluid level in the system, system operating conditions, or the like. The user equipment may display data and/or send a communication to an end user that enables or assists a user to diagnosis and/or assess the condition of the refrigeration system. User equipment includes, but is not limited to, a cellular phone, tablets, a computer, a controller, a processor, or any device able to receive a communication from the transmitter. In some embodiments, the user equipment is a cellular phone. The phone may include one or more applications that receives and processes the data.

The processed data may be displayed as pressure measurements, temperature measurements, calculated subcool and/or superheat values, and/or the amount fluid in the refrigeration in the refrigeration system. In some embodiments, other received data representative of other physical parameters is processed and displayed.

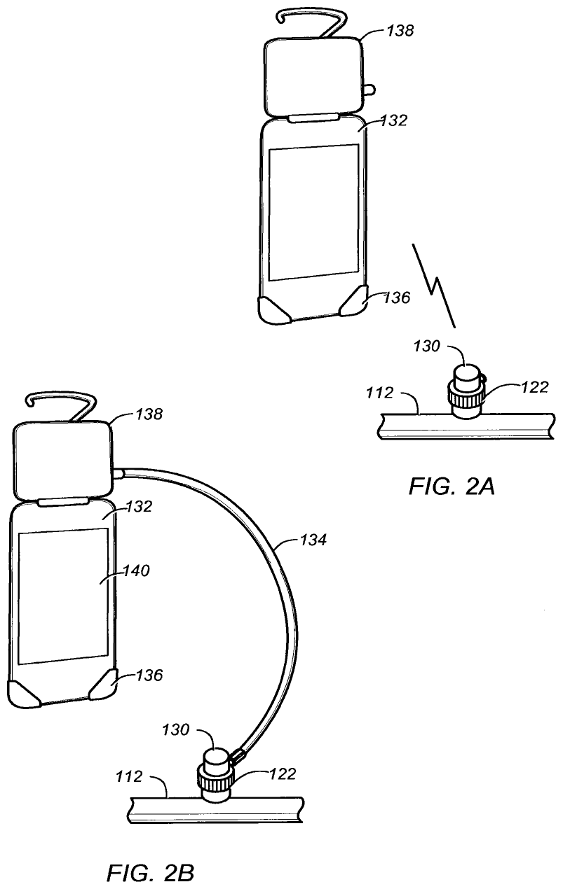

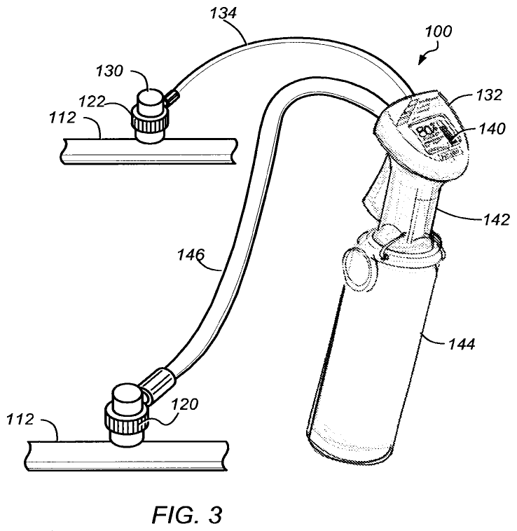

FIGS. 2-6 depict embodiments of servicing a refrigeration system. FIGS. 2A and 2B depict embodiments of obtaining one or more parameters from a vehicle refrigeration system. As shown in FIGS. 2A and 2B, sensor 130 is coupled to high-pressure port 122 of a refrigeration system, however, it is envisioned that the sensor may be coupled to the low-pressure port 120, or another portion of the vehicle refrigeration system. FIG. 3 depicts an embodiment of a fluid charging device coupled to first portion of a refrigeration system while obtaining data from a second portion of a refrigeration system through a wired connection.

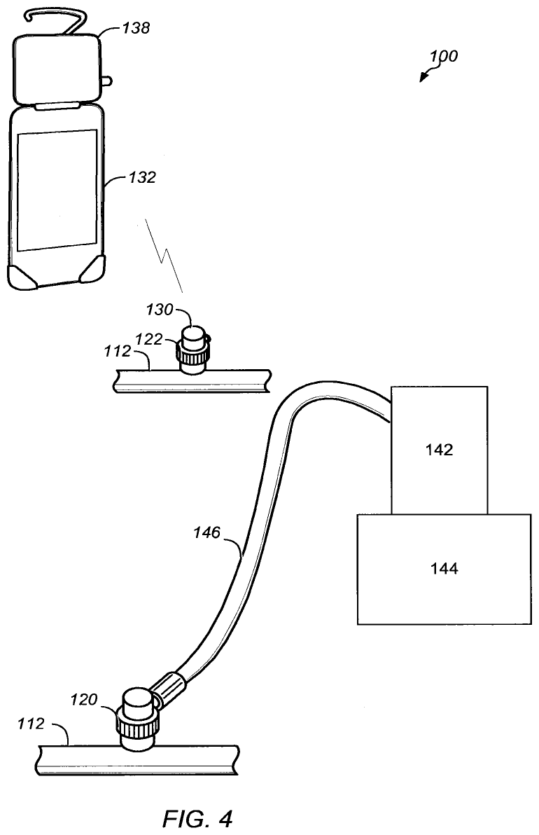

FIG. 4 depicts an embodiment of a fluid charging device coupled to first portion of a refrigeration system while obtaining data using a cellular device.

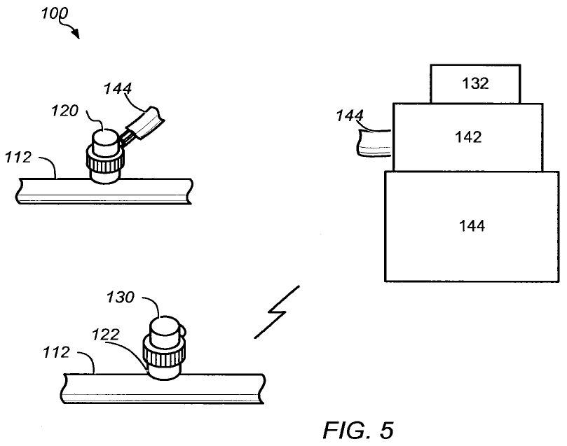

FIG. 5 depicts schematic of another embodiment of a fluid charging device coupled to a portion of a refrigeration system while obtaining data from another portion of the vehicle refrigeration system through a wireless transmission.

In some embodiments, sensor 130 includes one or more sensors that measures physical properties of the refrigeration system and/or a fluid in a refrigeration system. For example, sensor 130 is or includes a pressure sensor. Sensor 130 may be positioned in the interior portion of piping 110 or 112 of refrigeration system 100. In some embodiments, sensor 130 is a set of sensors or includes two sensors (for example, a pressure sensor and a temperature sensor). As shown in FIGS. 2A and 2B, sensor 130 is coupled to high-pressure port 122 of a vehicle refrigeration system, however, it is envisioned that the sensor may be coupled to the low-pressure port 120, or another portion of the vehicle refrigeration system. Refrigeration system may be in use (for example, refrigerant is circulating through the fluid lines). A temperature and pressure of the fluid in the refrigerant system may be obtained during operation of the refrigeration cycle using sensor 130. Sensor 130 may electronically transmit the information to user equipment 132. As shown in FIG. 2A, sensor 130 communicates with user equipment by a short range wireless signal. As shown in FIG. 2B, sensor 130 communicates with user equipment 132 through cable 134.

In some embodiments, sensor 130 is removed from the refrigeration system and the collected data is transmitted to user equipment 132. In some embodiments, user equipment 132 is used to charge a power supply of sensor 130.

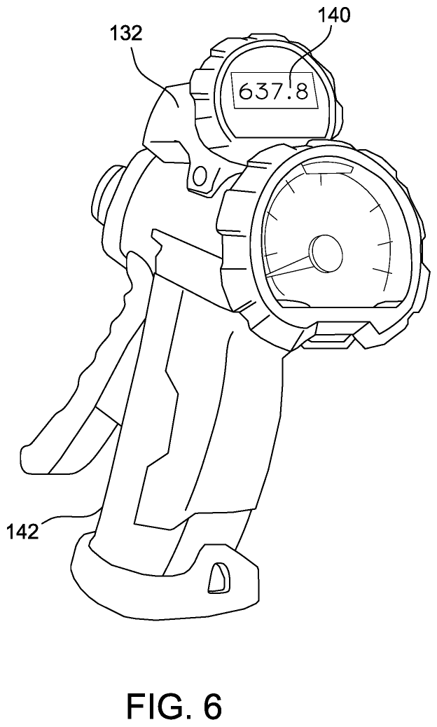

As shown in FIGS. 2A and 2B user equipment 132, is a cellular phone. User equipment 132 may include case 136. Case 136 may include holding device 138. Holding device 138 may allow “hands free” use of user equipment 132. As shown in FIG. 6, user equipment is positioned on a fluid source to provide “hands free” use of user equipment 132. “Hands free” use of user equipment 132 may allow a user to service the refrigeration system while determining the physical properties of the system. For example, sensor 130 transmits data to user equipment 132.

In some embodiments, a temperature sensor is coupled to a portion of the vehicle or the vehicle refrigeration system and the user equipment. For example, the temperature sensor may clip to an air conditioning vent of a vehicle and a cord connected to the temperature sensor may plug into a port of the user equipment (for example, a headphone jack and/or a USB port). In some embodiments, the temperature obtained from the temperature sensor is used in determining a level of refrigerant in the system. In some embodiments, the temperature is a second temperature sensor that is determining the level of cooling in the interior of the vehicle.

User equipment 132 displays a level of refrigerant in the refrigerant system based on the sub cooling properties of the fluid. Based on the assessed level of refrigerant in the system, refrigerant may be added or removed from the low-pressure port of the refrigerant system while the sensor is attached to another portion of the refrigeration system (for example, the high pressure port of the refrigerant system). As the refrigerant is added or removed (charged) through the low-pressure port, user equipment 132 displays a refrigerant level (or amount) in the system in real time. Thus, a more accurate charging of the refrigerant system may be performed as compared to the use of manual gauges and charts, and/or assessing condition of the refrigeration unit using data obtained from the low-pressure side of the refrigeration system.

In some embodiments, user equipment 132 may include one or more applications that processes the data signals received from sensor 130, and displays values obtained by processing the data signals. Screen 140 may display one or more values obtained from the data sent by sensor 130 or other sensors coupled to the refrigerant system or coupled to the vehicle Screen 140 may display one or more parameters of the refrigeration system, for example, temperature and/or pressure and/or graphics representing the fluid level in the refrigeration system. The user equipment may display a pressure and temperature from a pressure component and a temperature component located in sensor 130 and a level of refrigerant in the system. In some embodiments, the user equipment displays a pressure and temperature from a pressure component and a temperature component located in sensor 130 and a temperature measurement from a temperature sensor located coupled to the refrigeration system.

As shown in FIG. 3, user equipment 132 is a part of fluid charging apparatus 142, which is coupled to fluid source 144. As shown in FIG. 4, user equipment 132 is wirelessly coupled to high-pressure port 122, and fluid charging device 142 is coupled to fluid source 144 and low pressure port 120. As shown in FIGS. 5 and 6, user equipment 132 is coupled to fluid charging apparatus 142. As shown in FIG. 6, user equipment 132 is removably attached to an outer surface of fluid charging apparatus 142. Examples of fluid charging apparatus are described in U.S. Pat. No. 7,260,943 to Carrubba and U.S. Patent Application Publication Nos. 2012-0192579 to Carrubba and 2013-0118187 to Carrubba, all of which are incorporated herein by reference in their entirety.

Fluid charging device 142 may be connected to fluid source 144 and fluid transfer device 146. Fluid transfer device 146 may be, but is not limited to, a hose, a conduit, or the like. Fluid source 144 may include one or more fluids for charging a vehicle refrigerant system. Fluid source 144 may be pressurized or, in some embodiments, under a vacuum. In some embodiments, fluid source 144 is at atmospheric pressure. During use, user equipment 132 may display one or more parameters of the system while fluid charging device is connected to low-pressure port 120. As shown in FIG. 3, user device 132 receives a communication from sensor 130 through cable 134 while fluid charging apparatus 142 is connected to low-pressure port 120 of the vehicle refrigeration system. As shown in FIG. 4, user device 132 receives a wireless communication from sensor 130 while fluid charging apparatus 142 is connected to low-pressure port 120 of the vehicle refrigeration system.

A method of servicing a vehicle refrigeration system includes providing sensor 130 to a portion of the refrigeration system (for example, high-pressure port 122 of the refrigeration system) where the sensor is located in situ with the refrigerant in a portion of the refrigeration system. In some embodiments, an adapter includes sensor 130. The adapter may be coupled to high pressure port 122 and/or low pressure port using coupling means known in the art (for example, a quick-disconnect coupling, a threaded coupling or the like). User equipment 132 may be coupled to a portion of the vehicle using holding device 138 (for example, hung from an inner portion of the hood of a vehicle). The user equipment 132 may be activated to receive the data obtained from sensor 130. Pressure and/or temperature data may be received from sensor 130 and/or from other sensors coupled to the refrigeration system or the fluid source by user equipment 132, processed, and then displayed on screen 140. In some embodiments, a pressure and temperature sensor measurements are displayed at sensor 130 and/or charge level is displayed at the sensor location.

In some embodiments, a level of fluid in the vehicle refrigeration system may be assessed by user equipment 132 based on received pressure and temperature data from sensor 130 and/or other sensors located in the vehicle refrigeration system. The assessment of the fluid level (or amount) may be done by determining the subcooling and/or superheating properties of the fluid in the system and comparing the determined properties to known subcooling or superheating properties for the same fluid. The fluid level may be displayed on processor screen 140. For example, the display may read high, low, or full. In some embodiments, screen 140 is a touch screen.

If the fluid level is high or low, refrigerant may be removed or added via low-pressure port 120 while monitoring the level of the fluid level using the data being obtained at high pressure port 122. Once a fluid level is adequate, sensor 130 is decoupled from high-pressure port 122. In some embodiments, the sensor is left in place and cable to the sensor is disconnected.

The user equipment and/or sensor may include a processor that may execute one or more program instructions stored in a memory or a carrier medium coupled to the user equipment or sensor. A non-transitory memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first processor in which the programs are executed, or may be located in a second different processor that connects to the first processor over a network, such as the Internet. In the latter instance, the second processor may provide program instructions to the first processor for execution. The term “memory medium” may include two or more memory mediums that may reside in different locations, e.g., in different computers that are connected over a network.

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

We claim:

1. A system for assessing and servicing a vehicle refrigeration system, the system comprising:
at least one sensor configured for attachment to an air vent portion of a vehicle and configured to collect at least one measurement; and
at least one user device communicatively coupled to the at least one sensor, and configured to:
receive the at least one measurement from the at least one sensor;
process the at least one measurement to generate at least one result; and
display the at least one result.

2. The system of claim 1, wherein the at least one measurement comprises a first temperature and a second temperature obtained by the at least one sensor, and, wherein processing the first temperature generates a first result including a level of refrigerant in the vehicle refrigeration system and processing the second temperature generates a second result including a level of cooling inside the vehicle.

3. The system of claim 1, wherein the at least one measurement is related to the air vent of the vehicle.

4. The system of claim 1, wherein the at least one user device is coupled to the at least one sensor via at least one of a headphone jack, a USB port, or a short-range wireless connection.

5. The system of claim 1, wherein displaying the at least one result including at least one of a level of refrigerant in the vehicle refrigeration system or a level of cooling inside the vehicle and wherein the at least one result is updated in real-time.

6. A method for assessing and servicing a vehicle refrigeration system, the method comprising:
attaching at least one sensor to an air vent portion of a vehicle;
measuring, by the at least one sensor, at least one measurement;
receiving, by at least one user device, the at least one measurement;
processing, by the at least one user device, the at least one measurement to generate at least one result; and
displaying, on the at least one user device, the at least one result.

7. The method of claim 6, wherein the at least one measurement comprises a first temperature and a second temperature obtained by the at least one sensor, and,
wherein processing the first temperature generates a first result including a level of refrigerant in the vehicle refrigeration system and processing the second temperature generates a second result including a level of cooling inside the vehicle.

8. The method of claim 6, wherein the at least one measurement is related to the air vent of the vehicle.

9. The method of claim 6, wherein the at least one user device is coupled to the at least one sensor via at least one of a headphone jack, a USB port, or a short-range wireless connection.

10. The method of claim 6, wherein displaying the at least one result including at least one of a level of refrigerant in the vehicle refrigeration system or a level of cooling inside the vehicle and wherein the at least one result is updated in real-time.

11. A system for servicing a vapor compression refrigeration system of a vehicle, comprising:
a first sensor configured to be in fluid communication with a low pressure port of the vapor compression refrigeration system and configured to take at least one first measurement;
a second sensor configured to be in fluid communication with an interior air vent of the vehicle and configured to take at least one second measurement;
at least one user device communicatively coupled to the first sensor and the second sensor, and configured to:
receive the at least one first measurement and at least one second measurement;
process the at least one first measurement and the at least one second measurement to generate at least one result; and
display the at least one result.

12. The system of claim 11, wherein the at least one second measurement comprises a temperature obtained by the at least one sensor.

13. The system of claim 12, wherein processing the temperature generates a result including a refrigerant level in the vapor compression refrigeration system.

14. The system of claim 11, wherein the at least one first measurement comprises a pressure obtained by the at least one sensor.

15. The system of claim 14, wherein processing the pressure generates a result including a refrigerant level in the vapor compression refrigeration system.

16. The system of claim 11, wherein the first sensor is configured to wirelessly transmit a signal indicative of the at least one first measurement.

17. The system of claim 11, wherein the at least one user device is communicatively coupled to the first sensor or the second sensor via at least one of a headphone jack, a USB port, or a short-range wireless connection.

18. The system of claim 11, wherein the at least one user device is wirelessly connected to the first sensor or the second sensor.

19. The system of claim 11, wherein displaying the at least one result includes displaying a level of refrigerant in the vapor compression refrigeration system.

20. The system of claim 19, wherein the at least one user device is further configured to update, in real-time, the at least one result displayed.
